(19) United States
(12) Patent Application Publication
(10) Pub. No.: US 2026/0262876 A1
(43) Pub. Date: Sep. 10, 2026

(54) BEVERAGE DISPENSING MACHINE COMPRISING A CLEANING DEVICE

(71) Applicant: Melitta Professional Coffee Solutions GmbH, Minden (DE)

(72) Inventors: Bernd BUCHHOLZ, Rahden (DE); Jörg OSTERMEIER, Stadthagen (DE); Elaine ELLERBROK, Herford (DE); Jan SCHULZE, Minden (DE); Horst SCHMIDT, Bad Oeynhausen (DE)

(73) Assignee: Melitta Professional Coffee Solutions GmbH, Minden (DE)

(21) Appl. No.: 19/162,503

(22) PCT Filed: Mar. 4, 2024
(86) PCT No.: PCT/EP2024/055624

§ 371 Date: Sep. 5, 2025

(30) Foreign Application Priority Data
Mar. 8, 2023 (DE) 10 2023 105 705.7

(51) Int. Cl. A47J 31/60; A47J 31/40; B08B 9/032

(52) U.S. Cl. CPC A47J 31/60; A47J 31/402; B08B 9/0321; B08B 2209/032

(57) ABSTRACT

A beverage dispensing machine includes a cleaning device, at least one first beverage system and at least one second beverage system. The second beverage system has at least one inlet line for an added substance, which is attached to at least one attachment unit, which is connected to the at least one beverage system. The at least one attachment unit has at least one first port, to which the at least one inlet line for the added substance is securely attached with a first line end, and at least one second port, wherein the at least one second port forms a releasable connection to a second, free line end of the at least one inlet line for the added substance. A method for cleaning a beverage dispensing machine that includes a cleaning device, at least one first beverage system and at least one second beverage system is made available.

The invention relates to a beverage dispensing machine, in particular a coffee machine, having a cleaning device according to the preamble of claim 1 and a method for cleaning such a beverage dispensing machine.

Beverage dispensing machines, such as cold and hot beverage machines, in particular coffee machines, have beverage systems with various functional units, including pipes, heat exchangers, etc., for beverage production. In a coffee machine for the production of coffee, in particular coffee production with the addition of milk or milk foam, the beverage systems are a coffee system and a milk system.

The areas of the coffee and milk system of the coffee machine through which the hot or cold beverage flows, preferably the pipe(s), must be carefully cleaned regularly with a cleaning liquid. The cleaning liquid used for this is usually water in which a cleaning substance has been/is dissolved. In order to ensure sufficient cleaning in areas through which hot and/or cold beverages, especially milk, flow, a sufficient amount of cleaning substance must be added to the water.

“Areas through which hot and/or cold beverages flow” means in the following that only coffee, tea, water, chocolate/cocoa or milk or milk as part of a hot or cold beverage flows through the area or areas.

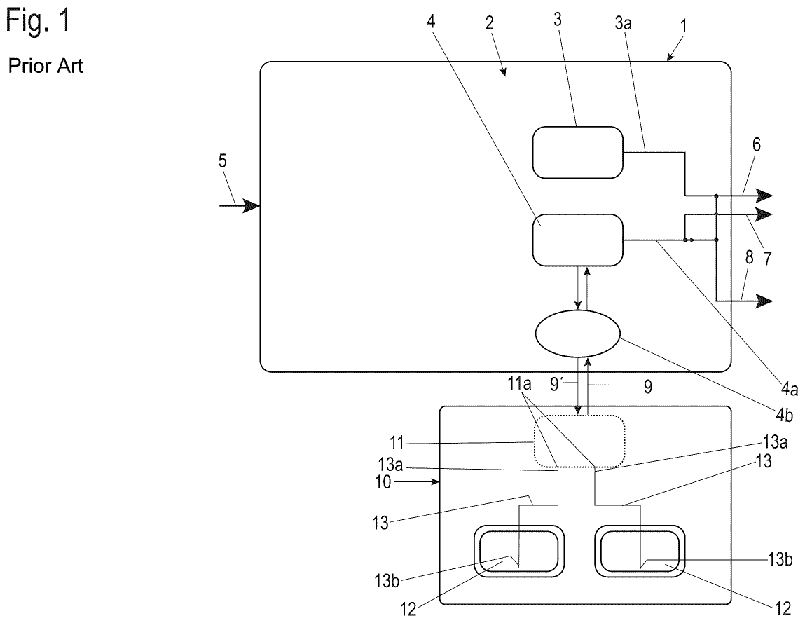

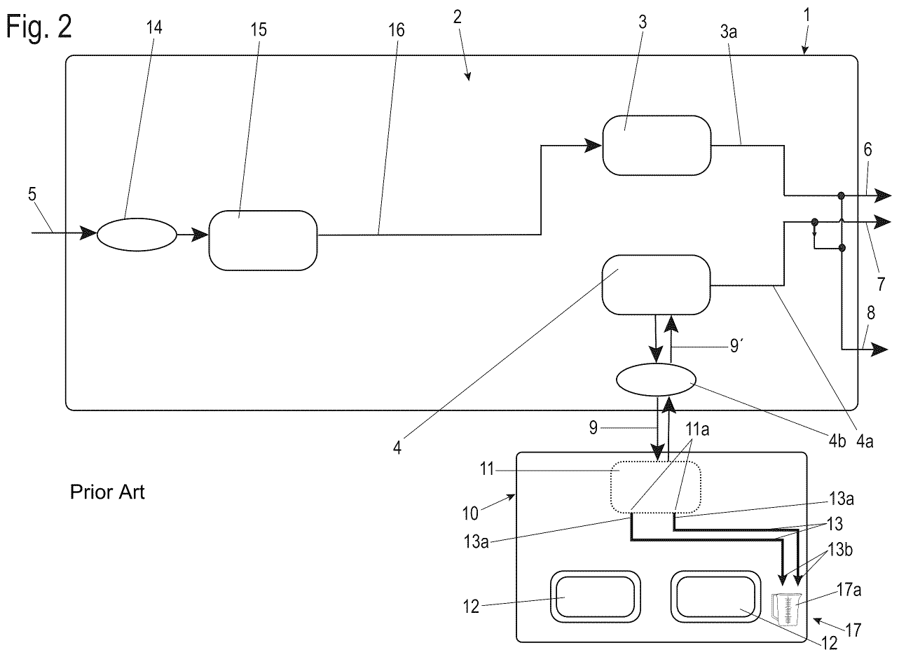

FIGS. 1 and 2 show schematic block diagrams of an exemplary embodiment of a coffee machine 1 with a cleaning device 2 according to the prior art. FIG. 1 shows the coffee machine 1 during a brewing process. The cleaning device 2 is only indicated here by its reference symbol. FIG. 2 shows the coffee machine 1 with the cleaning device 2 during a cleaning process according to the prior art.

The coffee machine 1 is a beverage preparation machine and is shown in simplified form. The description below is only exemplary and may also apply to other beverage preparation machines in a similar way.

The coffee machine 1 here comprises the cleaning device 2, at least one first beverage system 3 and at least one second beverage system 4. In the case of the coffee machine 1, the first beverage system 3 is a coffee system. The second beverage system 4 is a milk system.

The cleaning device 2 is used to clean the first beverage system 3 (coffee system), the second beverage system 4 (milk system) and the associated pipes.

The cleaning device 2 according to the prior art comprises a first cleaning agent input unit 15 for the first beverage system 3 (coffee system) and a separate second cleaning agent input unit 17, here in the form of a cleaning agent container 17a, for the second beverage system 4 (milk system).

The first cleaning agent input unit 15 is arranged in a supply line 16 between a water inlet 5 and the first beverage system 3 (coffee system).

The first cleaning agent input unit 15 has a device for feeding a cleaning agent into the supply line 16. This cleaning agent can be in liquid or solid form. In solid form, the cleaning can, for example, be inserted into a suitable insertion part of the cleaning agent input unit. The cleaning agent is also referred to as a cleaning substance.

The first beverage system 3 (coffee system) is connected to the water inlet 5 via the supply line 17. The water inlet 5 can also be connected to a water container (not shown).

A water sensor 14 is also arranged in the supply line 17 to the first beverage system 3 (coffee system), which is connected to the water inlet 15 and is used to detect a water pressure, a water quantity and also the quality of the water fed into the water inlet 5.

To prepare a beverage, the first beverage system 3 (coffee system) prepares a coffee beverage in a first operating state of the coffee machine 1 using the supplied water and ground coffee (not shown). The coffee beverage prepared in this way is supplied via a coffee line 3a by a coffee machine.

An additive can be added to the coffee beverage. In this case, this additive is milk, which is conveyed from the second beverage system 4 (milk system) through an additive line 4a into an additive outlet 7. In this way, the additive is subsequently added through the additive outlet 7 to the coffee already present in a container under the outlets 6 and 7. It is of course also possible for coffee to be introduced into the container through the beverage outlet 6 and additive through the additive outlet 7 at the same time.

The additive, i.e. the milk, is drawn here by means of a supply line 9, 9′ from a container 12 (here: two containers 12) of a beverage unit 10. There can also be more than two containers 12. For this purpose, one inlet line 13 is provided for each container 12. The container 12 can also be a bag in a container or a milk carton.

Two arrows in different directions are shown here for the supply line 9, 9′. This is intended to symbolize that, on the one hand, milk is drawn out of the milk container in the direction of the arrow on the supply line 9′. On the other hand, during a cleaning process, which will be described in detail below, cleaning substance is fed through the supply line 9, 9′ in both directions.

Each input line 13 is either completely flexible or at least partially flexible and has a first line end 13a, with which each input line is firmly connected to a first connection 11 a of a connection unit 11 in a suitable manner, for example with suitable pipe/hose connections.

A second, free line end 13b of each input line 13 is immersed in the liquid (additive) contained in the associated container 12.

The connection unit 11 forms an interface between the supply line 9, 9′ and the input lines 13. In a simple embodiment, the connection unit 11 is designed as a branch from the supply line 9, 9′ into the input lines 13. In another embodiment, the connection unit 11 can have valves (not shown, but easily imaginable) for individually connecting/blocking the input lines 13 or/and the supply line 9, 9′.

A sensor 4b is inserted in the supply line 9, 9′, which detects a flow rate in the supply line 9, 9′.

The beverage unit 10 can be refrigerated, e.g. a refrigerator.

The second cleaning agent input unit 17 is arranged here in the beverage unit 10 and is designed as a cleaning agent container 17a, into which liquid cleaning agent can be poured. Of course, cleaning agent powder or tablets can also be added in water and dissolved beforehand or in water in the cleaning agent container 17a.

During a cleaning process in a second operating state of the coffee machine 1, the first beverage system 3 (coffee system) and the second beverage system 4 (milk system) are cleaned separately by means of the cleaning device 2, starting from the two different cleaning agent input units 15 and 17.

For the first beverage system 3 (coffee system), cleaning takes place from the first cleaning input unit 15, through the supply line 16, the first beverage system 3 (coffee system) and the coffee line 3a into an outlet 8.

Preparations must be made for the second beverage system 4 (milk system), which is separate from this, wherein the flexible input lines 13 or their flexible parts are removed with the respective second line end 13b from the respective container 12 and inserted with their first, free line ends 13a into the cleaning agent container 17 of the second cleaning agent input unit 17. The containers 12 are removed, cleaned separately or replaced by new containers 12. The containers 12 can, for example, also be commercially available beverage containers such as bags, cartons or the like.

Cleaning is then carried out from the cleaning agent container 17a of the second cleaning agent input unit 17 through the input lines 13, the connection unit 11, the supply lines 9 and/or 9′ (supply line 9′ for recirculation), the second beverage system 4 (milk system), the additive line 4a and then into the outlet 8.

A cleaning agent for the first beverage system 3 (coffee system) is fed into the first cleaning agent input unit 15, mixed with or dissolved in water and fed to the first beverage system 3 (coffee system) through the supply line 16. The cleaning liquid then flows through the coffee line 3a into an outlet 8, where the coffee line 3a is also cleaned.

Another cleaning agent for the second beverage system 4 (milk system) is filled into the cleaning agent container 17a of the second cleaning agent input unit 17. The cleaning agent can then be drawn from the cleaning agent container 17a of the second cleaning agent input unit 17 by the second beverage system 4 (milk system) via the input lines 13, the connection unit 11 and the supply line 9′ or 9 and passed through the second beverage system 4 (milk system). After cleaning the second beverage system 4 (milk system), the cleaning agent passes through the additive line 4a into the outlet 8. In this way, the lines 13, 9, 9′ and 4a and the connection unit 11 are cleaned.

After the cleaning process, a final rinsing process of the first beverage system 3 (coffee system), the second beverage system 4 (milk system) and the associated lines can be carried out with water, for example.

The input lines 13 must then be reinserted with their second, free line ends 13b into the associated, possibly new or separately cleaned, containers 12.

The document DE 10 2011 077 435 A1 relates to a cleaning system for hot beverage dispensing machines.

The document EP 1 911 382 A1 specifies a device for preparing and dispensing beverages with a cleaning device.

The document DE 10 2013 112 130 A1 describes a method for detecting cleaning substances in a beverage machine, in particular a coffee machine.

These embodiments have proven themselves, but there is a constant need for improvements in the course of cost savings on components, functional groups, assembly times and maintenance.

The invention therefore has the object of improving a beverage dispensing machine, in particular a coffee machine, with a cleaning device, wherein simplification of cleaning and cost savings can be made possible.

A further object is to specify an improved method for cleaning a beverage dispensing machine.

The invention solves this object by a beverage dispensing machine comprising a cleaning device having the feature of claim 1 and by a method for cleaning a beverage dispensing machine according to claim 8.

A beverage dispensing machine according to the invention, in particular a coffee machine, comprises a cleaning device, at least one first beverage system and at least one second beverage system, wherein the at least one second beverage system has at least one input line for an additive, in particular milk, wherein the at least one input line for the additive is connected to at least one connection unit which is connected to the at least one beverage system. The at least one connection unit has at least one first connection, to which the at least one input line for the additive is permanently connected with a first line end, and at least one second connection, wherein the at least one second connection forms a detachable connection with a second, free line end of the at least one input line for the additive.

This is advantageous as it prevents any mix-ups between the connections. In addition, the detachability of the second, free line end at the additional connection of the connection unit offers safe, simple and quick handling.

A further advantage is that the simple version of the connection unit consists of only one or more connections, wherein the input lines can be connected and disconnected quickly and easily. It is understood that it is also possible for this connection unit to be larger and have its own housing with additional functions, such as stopcocks, valves, displays, etc.

A method according to the invention for cleaning a beverage dispensing machine, in particular coffee machine, having a cleaning device, at least one first beverage system and at least one second beverage system, wherein the at least one second beverage system has at least one input line for an additive, in particular milk, comprises the method steps (VS1) feeding a cleaning agent or cleaning substance in solid, liquid or/and powdered form into a cleaning agent input unit of the cleaning device; (VS2) preparing a beverage unit of the at least one second beverage system by removing at least one input line for the additive with its second, free line end from a container and connecting it to a second connection of a connection unit, detecting the second, free line end of the at least one input line connected in this way by means of a sensor; and (VS3) cleaning both the first beverage system and the second beverage system after the connected second, free line end of the at least one input line has been detected.

A particular advantage here is that, on the one hand, no additional cleaning container is required and, on the other hand, a cleaning process can only take place once the input line has been connected with its free line end. This ensures safe handling of the input lines, which are therefore always included in the cleaning process.

Advantageous designs are described in the subclaims.

In one embodiment, it is provided that the second, free line end of the at least one input line for the additive is arranged in a container of the additive during a first operating state of the coffee machine, in which the coffee machine prepares a beverage. In this way, the input line can continue to be used to draw in the additive as usual and, advantageously, no additional components are required.

A still further embodiment provides that the second, free line end of the at least one input line for the additive is detachably connected to the at least one second connection of the at least one connection unit during a second operating state of the coffee machine, in which the coffee machine is cleaned. In this way, a loop of the input line is formed so that it is advantageously included in the cleaning process in such a way that it can be completely cleaned, wherein the cleaning liquid is discharged again via the second connection of the connection unit. Advantageously, no cleaning work is required in the area of the input lines.

It is also advantageous if the at least one second connection of the at least one connection unit has a sensor which detects a connection of the at least one second connection to the second, free line end of the at least one input line for the additive, since in this way a cleaning process can only be started when the input line(s) is/are fully connected to its/their second line end(s).

A further advantage is that the at least one second connection of the at least one connection unit is designed as a hose nozzle or/and a quick coupling, as this allows the input line to be connected and disconnected quickly and safely.

In a further embodiment, it is advantageous if the cleaning device has a sensor for detecting and monitoring the cleaning substance, as this can be used to determine whether cleaning agent is present or no longer present.

In another embodiment, the cleaning device has a common cleaning agent input unit for a cleaning substance for both beverage systems. This is advantageous as a number of components can be saved.

A further embodiment of the method provides that in the method step of feeding (VS1), the fed cleaning agent or fed cleaning substance is mixed with water and prepared. In this way, a simple cleaning agent preparation can advantageously also take place in the coffee machine.

In a still further embodiment of the method, after the cleaning process at the end of the method step of cleaning (VS1), the at least one input line with its second, free line end is removed again from the second connection of the connection unit and arranged in a new container. This is possible in an advantageously simple and quick manner. For this purpose, the second connection of the connection unit can have a quick coupling.

Another embodiment of the method provides that the presence of the cleaning agent or cleaning substance in the lines and beverage systems is detected and monitored by means of at least one sensor during cleaning in the third method step of cleaning (VS3). This advantageously ensures that no more cleaning agent is present during the subsequent beverage preparation. For this purpose, an acoustic and/or visual signaling can also be advantageously provided when the cleaning process is complete or there is no more cleaning agent or cleaning substance in the lines and beverage systems.

In the following, the invention is described in more detail with reference to the drawings by means of an exemplary embodiment. The figures serve only to explain the invention in more detail and are not limiting for the invention. Individual features described can also be transferred to other embodiment variants within the scope of general technical knowledge, wherein:

FIGS. 1-2: show schematic block diagrams of an exemplary embodiment of a coffee machine having a cleaning device according to the prior art;

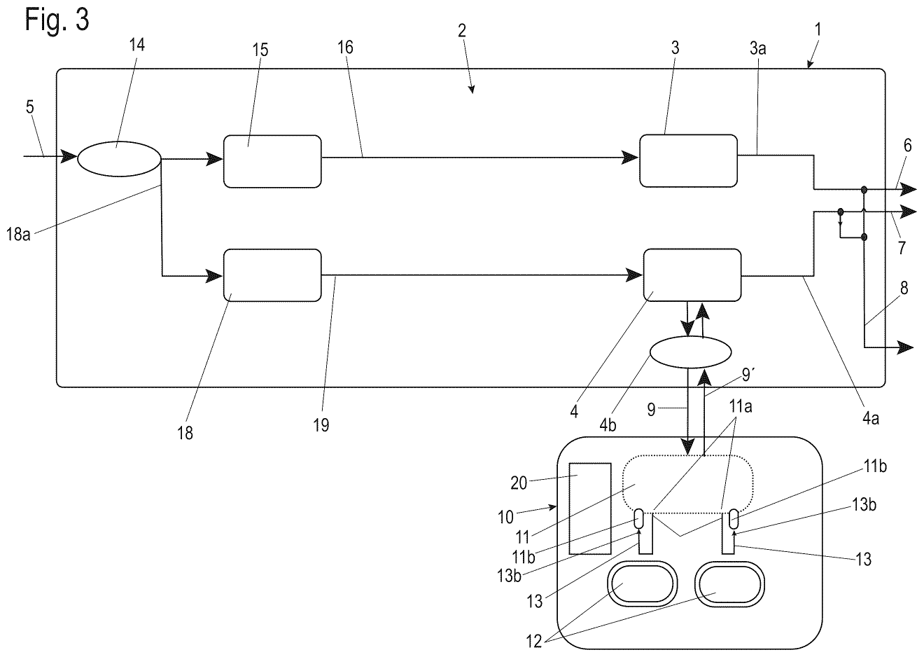

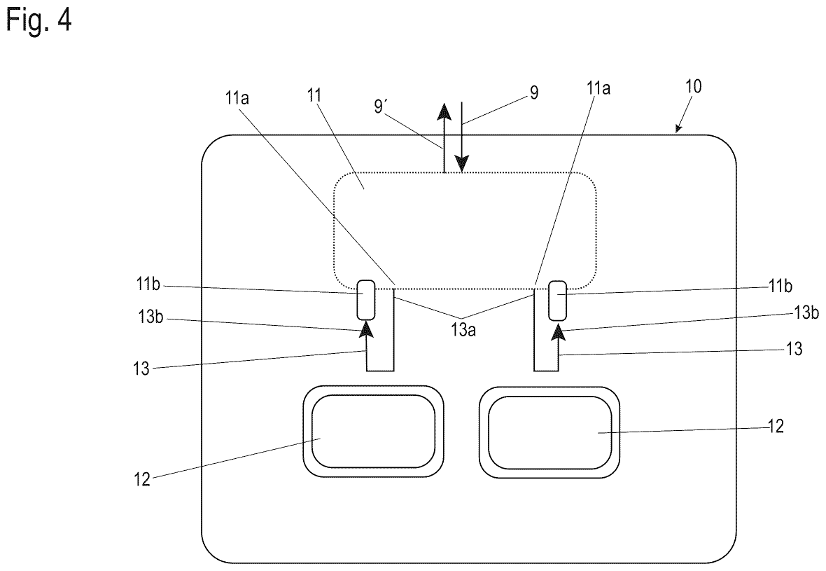

FIGS. 3-4: show schematic block diagrams of an exemplary embodiment of a coffee machine according to the invention with a cleaning device; and

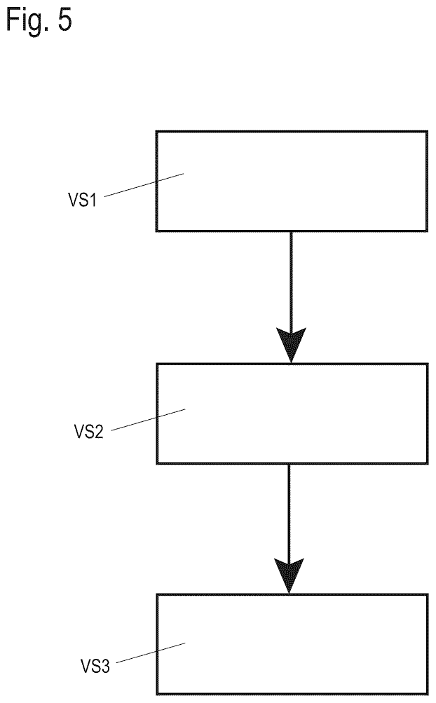

FIG. 5: shows a schematic flow chart of a method according to the invention.

FIGS. 1 and 2 have already been described above.

FIG. 3 shows a schematic block diagram of an exemplary embodiment of a coffee machine 1 according to the invention having a cleaning device 2. FIG. 4 shows an enlarged schematic view of a beverage unit 10 according to FIG. 3 in a block representation.

The coffee machine 1 according to the invention comprises here the cleaning device 2, at least one first beverage system 3 (coffee system) and at least one second beverage system 4 (milk system), to which a beverage unit 10 is assigned. Containers 12 of the beverage, i.e. in this case the milk, are arranged in the beverage unit 10. The beverage unit 10 can, for example, be a refrigerated container such as a refrigerator.

The first beverage system 3 (coffee system) is connected to the beverage outlet 6 via the coffee line 3a and the second beverage system 4 (milk system) is connected to the additive outlet 7 via the additive line 4a as already described above. The connections to the outlet 8 have also already been explained above.

The cleaning device 2 of the coffee machine 1 according to the invention comprises a first cleaning agent input unit 15 for the first beverage system 3 (coffee system) with the associated supply line 16, and a separate second cleaning agent input unit 20 in the beverage unit 10 for the second beverage system 4 (milk system) as well as a connection unit 11 for at least one input line 13 for the additive, which in this case is milk.

The first cleaning agent input unit 15 is arranged in a supply line 16 between a water inlet 5 and the first beverage system 3 (coffee system).

The at least one input line 13 has a first line end 13a and a second, free line end 13b. With the first line end 13a, the at least one input cable 13 is permanently connected to the connection unit 11 at a connection 11a. The second, free line end 13b is freely movable relative to the first line end 13a and is arranged in the container 12 in the operating state of the coffee machine 1, in which it prepares beverages, so that milk can be drawn out of the container 12 via the associated input line 13.

The connection unit 11 of the coffee machine 1 according to the invention with the cleaning device 2 has at least one second connection 11b as a detachable connection for the free line end 13b of the at least one input line 13.

In a simple embodiment, the connection unit 11 can consist only of the connections 11a, 11b and associated connecting lines and be arranged on or in the second beverage system 4. It is of course also possible for the connection unit 11 to have its own housing.

When preparing to clean the second beverage system 4 (milk system), the at least one input line 13 is removed with its first, free line end 13a from the container 12 and then connected to the at least one second connection 11b of the connection unit 11. This is carried out, for example, in such a way that the line ends 13a are designed as a hose and are pushed over a corresponding hose nozzle of the respective second connection 11b of the connection unit 11. It is understood that other designs of the at least one input line 13 are also possible, e.g. an articulated tube or the like.

Instead of a hose nozzle, a suitable, standard hose connection, e.g. with a quick-release fastener, can of course also be used.

In this way, the at least one inlet line 13 forms a loop and can thus be flushed by the cleaning agent. A collecting container or the cleaning agent container 17a is not required.

For this purpose, the connection unit 11 can have valves, for example, with which such a circulating cleaning/flushing of the at least one inlet line 13 can be enabled. Different cleaning paths are possible.

In one variant of the cleaning process, the second beverage system 4 can also be cleaned only as far as the connection unit 11, wherein the second, free line ends 13b of the input lines 13 remain in their positions in the containers 12 and are blocked by valves in the connection unit 11. This variant of the cleaning process can, for example, be carried out daily, wherein the additional cleaning of the input lines 13, which are then connected to the second connection 11b of the connection unit 11 with their second, free line ends 13b, can be carried out at longer intervals as required.

A sensor (not shown, but easily imaginable) is assigned to the at least one second connection 11b of the connection unit 11. This sensor detects whether a line end 13a of the associated input line 13 is connected to the relevant second connection 11b or not.

This sensor can be, for example, a contact sensor, proximity switch or a microswitch, which is actuated by the connected line end 13a via a suitable plunger or the like.

The sensor is connected to an evaluation circuit of a control unit (also not shown, but easily imaginable) of the coffee machine 1. This ensures that the input lines are connected before the cleaning process begins.

For the cleaning process of the milk system 4, cleaning substance is introduced into the second cleaning input unit 20 in the beverage unit 10. The second cleaning agent input unit 20 can be connected in a manner not described in detail, for example to the connection unit 11, in order to introduce the cleaning substance into the second beverage system 4 (milk system).

A variant of the exemplary embodiment of the coffee machine 1 according to the invention is also shown in FIG. 3.

In this variant, a third cleaning agent input unit 18 is arranged in a supply line 19 between the water inlet 5 and the second beverage system 4 (milk system) and is connected to the water inlet 15 or the water sensor 14 via a connection 18a.

This third cleaning agent input unit 18 can be provided instead of or in addition to the second cleaning agent input unit 20.

In a further variant, which is not shown, the coffee machine 1 according to the invention has a cleaning device 2 with only one, i.e. with a common cleaning input unit 15. In other words, the cleaning agent input unit 15 is used to clean both the first beverage system 3 (coffee system) and the second beverage system 4 (milk system). Only one cleaning agent needs to be fed into the common cleaning agent input unit 15. This one cleaning agent cleans both systems, i.e. the first beverage system 3 (coffee system) and the second beverage system 4 (milk system).

For this purpose, the supply line 16 shown in FIG. 3 is also connected to the second beverage system 4 (milk system), e.g. via a branch. This branch can have one or more valves in order to either clean both beverage systems 3 and 4 simultaneously or individually.

The cleaning agent input unit 15 can be used for both beverage systems 3, 4 (alkaline cleaning) and the cleaning agent input unit 20 with acidic cleaning agent and/or descaler for the second beverage system 4 (milk system). It is also possible that both cleaning agents (alkaline and acidic) can be used for both beverage systems 3, 4, or that only one cleaning agent input unit 15, 18, 20 can be used for both beverage systems 3, 4.

FIG. 5 shows a schematic flow diagram of a method according to the invention for operating the cleaning device 2 of the coffee machine 1.

In a first method step VS1, a cleaning agent, for example in solid, liquid or/and powdered form, is fed into the first cleaning agent input unit 15 and into the second cleaning agent input unit 20 or 18.

The beverage unit 10 of the second beverage system 4 is then prepared for a cleaning process in a second method step VS2 by removing the at least one input line 13 with its second, free line end 13b from the container 12 and connecting it to at least one second connection 11b of the connection unit 11.

The second line end 13b connected to at least one second connection 11b or the connected second line ends 13b is/are detected by a respective sensor on the connection unit 11 and signaled to a control unit.

When the existing second line ends 13b of the input lines 13 are connected to the respective connections 11b of the connection unit 11, the cleaning process is started.

The cleaning agent concentrate is mixed or treated with water. It can also be stored in a storage tank (not shown). The water is monitored for pressure, quantity and quality using a suitable sensor.

In a third method step VS3, both the first beverage system 3 and the second beverage system 4 are cleaned. During cleaning, the presence of the cleaning agent in the beverage systems 3 and 4 is detected and monitored.

When the cleaning process is complete or there is no more cleaning agent in the pipes and beverage systems 3, 4, this is signaled in a suitable manner, e.g. acoustically and/or visually.

After the cleaning process, the at least one input line 13 is removed again with its second, free line end 13a from the at least one second connection 11b of the connection unit 11 and arranged in a new container 12.

The cleaning device 2 can be switched on by an operator as required or also when prompted by an operating system of the coffee machine 1 (e.g. on a display).

It is also possible for the cleaning processes of the cleaning device 2 to run automatically at specific time intervals.

The invention is not limited by the exemplary embodiment given above, but can be modified within the scope of the claims.

### LIST OF REFERENCE SIGNS

1 Coffee machine
2 Cleaning device
3 Beverage system
3a Coffee line
4 Beverage system
4a Additive line
4b Sensor
5 Water inlet
6 Beverage outlet
7 Additive outlet
8 Outlet
9, 9′ Supply line
10 Beverage unit
11 Connection unit
11b, 11b Connection
12 Container
13 Input line
13a, 13b Line end
14 Water sensor
15 Cleaning agent input unit
16 Supply line
17 Cleaning agent input unit
17a Cleaning agent container
18 Cleaning agent input unit
18a Connection
19 Supply line
20 Cleaning agent input unit
VS1, VS2, VS3 Method step

1. A beverage dispensing machine, comprising: a cleaning device (2), at least one first beverage system (3) and at least one second beverage system (4), wherein the at least one second beverage system (4) has at least one input line (13) for an additive, wherein the at least one input line (13) for the additive is connected to at least one connection unit (11) which is connected to the at least one beverage system (4),
wherein
the at least one connection unit (11) has at least one first connection (11a), to which the at least one input line (13) for the additive is permanently connected with a first line end (13a), and at least one second connection (11b), wherein the at least one second connection (11b) forms a detachable connection with a second, free line end (13b) of the at least one input line (13) for the additive.

2. The beverage dispensing machine according to claim 1, wherein the second, free line end (13b) of the at least one input line (13) for the additive is arranged in a container (12) of the additive during a first operating state of the coffee machine (1), in which the coffee machine (1) prepares a beverage.

3. The beverage dispensing machine according to claim 1, wherein the second, free line end (13b) of the at least one input line (13) for the additive is detachably connected to the at least one second connection (11b) of the at least one connection unit (11) during a second operating state of the coffee machine (1), in which the coffee machine (1) is cleaned.

4. The beverage dispensing machine according to claim 1, wherein the at least one second connection (11b) of the at least one connection unit (11) is designed as a hose nozzle or/and a quick coupling.

5. The beverage dispensing machine according to claim 1, wherein the at least one second connection (11b) of the at least one connection unit (11) has a sensor which is configured to detect a connection of the at least one second connection (11b) to the second, free line end (13b) of the at least one input line (13) for the additive.

6. The beverage dispensing machine according to claim 1, wherein the cleaning device (2) has a sensor configured for detecting and monitoring the cleaning substance.

7. The beverage dispensing machine according to claim 1, wherein the cleaning device (2) has a common cleaning input unit for a cleaning substance for both beverage systems (3, 4).

8. A method for cleaning the beverage dispensing machine according to claim 1, the method comprising the steps of
(VS1) feeding a cleaning agent or cleaning substance in solid, liquid or/and powdered form into a cleaning agent input unit (15, 18, 20) of the cleaning device (2);
(VS2) preparing a beverage unit (10) of the at least one second beverage system (4) by removing the at least one input line (13) for the additive with its second, free line end (13b) from a container (12) and connecting it to a second connection (11b) of a connection unit (11), detecting the second, free line end (13b) of the at least one input line (13) connected in this way by means of a sensor; and
(VS3) cleaning both the first beverage system (3) and the second beverage system (4) after the connected second, free line end (13b) of the at least one input line (13) has been detected.

9. The method according to claim 8, wherein in the method step (VS1), the fed cleaning agent or fed cleaning substance is mixed with water and prepared.

10. The method according to claim 8, wherein after the cleaning process at the end of the method step of cleaning (VS1), the at least one input line (13) is removed again with its second, free line end (13b) from the second connection (11b) of the connection unit (11) and arranged in a new container (12).

11. The method according to claim 8, wherein during cleaning in the third method step of cleaning (VS3), the presence of the cleaning agent or the cleaning substance in the lines and beverage systems (3, 4) is detected and monitored by means of at least one sensor, wherein an acoustic and/or visual signal is emitted when the cleaning process has ended or there is no longer any cleaning agent or cleaning substance in the lines and beverage systems (3, 4).
